(19) United States
(12) Patent Application Publication
(10) Pub. No.: US 2006/0000281 A1
(43) Pub. Date: Jan. 5, 2006

(54) Method and apparatus for assessing or predicting characteristics of wood or other wooden materials

(76) Inventor: Paul David Harris, Wellington (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/156,185

(22) Filed: Jun. 17, 2005

Related U.S. Application Data
(63) Continuation of application No. 10/333,526, filed on Aug. 14, 2003, now abandoned.

(30) Foreign Application Priority Data
Jul. 21, 2000 (NZ) 505896

(51) Int. Cl. G01N 9/24; G01M 7/00

(52) U.S. Cl. 73/579; 73/597; 73/573

(57) ABSTRACT

The present invention relates to apparatus and method for determining a characteristic, such as stiffness, of a log, stem, wood piece or other wood specimen. A wave generator produces a frequency varying signal which drives a transducer which is coupled to the specimen to impart a frequency varying acoustic wave into the specimen. A receiver sensor detects the resulting acoustic wave and a transmit sensor detects the output from the transducer. A characteristic response of the specimen is determined from the receiver sensor signal, transmit sensor signal and excitation signal using digital and analogue signal processing. The characteristic is determined from the characteristic response.

### FIELD

The invention comprises an improved method and apparatus for acoustically assessing or predicting one or more characteristics of a tree stem, log or wood piece, or of a wood composite material.

### BACKGROUND

Acoustic technology is increasingly being used in the forestry and processing industries as a means of predicting the inherent characteristics of wood and wood composite materials. It is a requirement of the building industry that the strength of a timber piece be sufficient for its purpose hence measurement of a log's modulus of elasticity utilising longitudinal acoustic waves as a probing means provides a convenient measure for the forestry industry as such measure is largely independent of the cross sectional area of the timber piece. Typically the sample, be it a tree stem, log, or other wood piece or piece of a wood composite material is hit by a hammer which induces a stress wave within the sample. This stress wave traverses the sample length with a velocity indicative of one or more inherent characteristics of the sample.

One type of instrument measures the time taken for a single traverse of the sample length and, knowing the sample length, the acoustic velocity is calculated. This method necessitates transducing both ends of the sample, or alternatively one end of the sample and the hammer. Most instruments use accelerometers to transduce the disturbance although in some instances displacement transducers are used. Commonly the stress wave is induced directly with a mechanical or pneumatic hammer, however the stress wave may be also be induced by an electronic hammer e.g. Silvatest. Usually in these instances the hammer comprises an electronic method of exciting a piezoelectric transmitter or transducer. The controlling electronic signal may be used to indicate the excitation of the sample. The crux is that the stress wave transit time measure is the time measured between excitation of the stress wave and its detection at the receiving transducer. A limitation to the usefulness of transit timer instruments is that the measure is prone to corruption by noise, due at least in part to the need for wide bandwidths to correctly identify starting and stopping points.

Another type of instrument records the reverberation of the stress wave within the sample, for a duration equivalent to many transit periods. A single receiver transducer only is required. The hit may occur at the same end as the receiving transducer. The spectral composition of the reverberation is determined typically by Fourier analysis and, knowing the sample length, the velocity calculated. Since many transits of the sample are recorded the calculated velocity is an average for the recording duration, preferably dominated by the plane wave reverberation. The hit must contain frequencies which match and excite the resonance's of the sample hence ideally an impulse is required generating the stress wave which has fast transitions and short period. To accurately determine a sample's velocity it is a requirement that the combination of hit amplitude and material absorption be such that the resonance is recorded for many reverberations. The sample's acoustic absorption dampens the stress wave and imparts an effective window function on the spectral signature, as the absorption increases the resonance peaks broaden (and shift) resulting in reduced accuracy. Generally resonance is less susceptible to random noise; interference on the other hand appears in the output as a sample resonance. Resonance techniques have an inherent ambiguity. A consequence of either the hit spectrum or sample support loading is that the fundamental or other overtones may not be excited or correctly identified. Then the velocity may be incorrectly identified by an integer or integer fraction for example 3, 2, ½, ⅓. Similarly the range of possible velocities may be constrained to less than a factor of two.

### SUMMARY OF INVENTION

In one aspect the present invention may be said to consist in a method of determining a characteristic of a wood specimen to assist in optimising use of the specimen including: exciting the specimen with a frequency varying excitation to impart an acoustic wave into the specimen, sensing a response indicative of the acoustic wave behaviour within the specimen, determining a response characteristic of the specimen using the sensed response, and determining the characteristic using the response characteristic.

In another aspect the invention may be said to consist in apparatus for determining a characteristic of a wood specimen to assist in optimising use of the specimen including: a transmitting transducer coupled to the specimen for generating a frequency varying excitation to impart an acoustic wave in the specimen, a first receiving transducer adapted to sense a response indicative of the behaviour of an imparted acoustic wave, and signal processing means adapted for determining a response characteristic from the sensed response, wherein the processing means is further adapted for determining the characteristic using the response characteristic.

In another aspect the present invention may be said to consist in apparatus for determining a characteristic of a sample log, stem, wood piece or a wooden composite to assist in optimising use of the sample including: a transducer for generating a frequency varying excitation coupled to the sample at a first position to impart an acoustic wave into the sample, a waveform generator to generate an excitation signal to drive the transducer, a first sensor in proximity to the transducer to sense the frequency varying excitation, a second sensor positioned to sense the response of the imparted acoustic wave within the sample, and a signal processor for determining a response characteristic of the sample from the sensed response, the sensed frequency varying excitation and the excitation signal, wherein the signal processing means further determines the characteristic from the response characteristic.

In another aspect the present invention may be said to consist in apparatus for determining a characteristic of a sample log, stem, wood piece or a wooden composite to assist in optimising use of the sample including: a transducer for generating a frequency varying excitation coupled to the sample at a first position to impart an acoustic wave into the sample, a waveform generator to generate an excitation signal to drive the transducer, a sensor coupled to sense a response indicative of the imparted acoustic wave, and a signal processor for determining a response characteristic of the sample from the sensed response, wherein the signal processing means further determines the characteristic from the response characteristic.

In another aspect the present invention may be said to consist in apparatus for determining a characteristic of a log or stem to assist in optimising use, the apparatus adapted for use with harvesting equipment and including: one or more drive rollers adapted to move the log or stem longitudinally a waveform generator to generate an excitation signal which stimulates the drive rollers to oscillate and excite the log or stem, a first sensor adapted to sense the excitation signal, a second sensor adapted to sense the response of the log or stem during oscillation, and a signal processor for determining a response characteristic of the sample from the sensed response and the sensed excitation signal, wherein the signal processing means further determines the characteristic from the response characteristic.

A method for assessing or predicting one or more characteristics of a tree stem, log or wood piece, or of a wood composite material (herein: specimen) comprising exposing the sample to a continuous excitation energy which varies at least in frequency over a defined time period, simultaneously detecting the resultant acoustic wave energy in the sample over the same time period via a receiver contacting or in proximity to the sample, and determining the sample characteristic(s) using the detected signal.

In another aspect the present invention may be said to consist apparatus for assessing or predicting one or more characteristics of a tree stem, log or other wood piece, or of a wood composite material, comprising transducer means arranged to expose the sample to excitation energy which varies at least in frequency over a defined time period, receiver means arranged to simultaneously detect the excitation energy in the sample over the same time period, and means arranged to determine the sample characteristic(s) from the detected signal.

### BRIEF DESCRIPTION OF THE FIGURES

The invention is further described with reference to the accompanying figures by way of example and without intending to be limiting, wherein:

FIG. 1 is a block diagram of an apparatus for determining a characteristic of a wood specimen,

FIGS. 2a-2e show various waveform representations used to generate an excitation signal for the apparatus,

FIGS. 2f-2i show waveforms present at various locations in the apparatus,

FIG. 2j shows a known resonant behaviour for analysing a characteristic response of the specimen,

FIGS. 3a, 3b are block diagrams show a preferred embodiment of the apparatus,

FIG. 4 is a flow chart showing the functionality of the apparatus,

FIG. 5 is block a diagram showing an alternative embodiment of the apparatus,

FIG. 6 is a flow chart showing the functionality of the alternative apparatus,

FIGS. 7a, 7b show output waveforms resulting from a multitone excitation signal,

FIG. 8a is a block diagram of an alternative waveform generator for generating a multitone excitation signal,

FIG. 8b is a flow chart of the functionality of the alternative waveform generator,

FIG. 8c shows a response resulting from processing of the output waveform shown in 7a,

FIG. 9a is a flow chart of the functionality of an alternative embodiment of the apparatus shown in FIG. 6 which implements segmented FFT analysis,

FIG. 9b is a graph showing the segmentation scheme,

FIG. 10 shows an implementation of the apparatus in harvesting equipment for logs and stems,

FIG. 11 shows a hydraulic system for driving the apparatus shown in FIG. 10,

FIG. 12 shows an implementation of the apparatus for sooks, ASTM samples and bolts,

FIGS. 13 and 14 show experimental results from the implementation shown in FIG. 12,

FIG. 15 shows an implementation of the apparatus in a portable form for testing logs.

### DETAILED DESCRIPTION OF PREFERRED FORMS

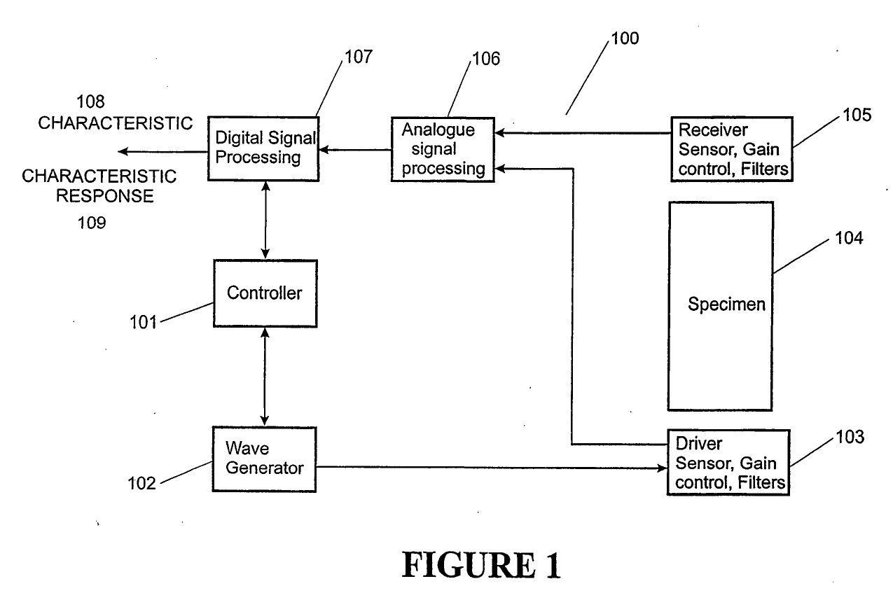

FIG. 1 is a schematic diagram providing a general overview of an apparatus 100 according to the invention for determining a characteristic of a sample or specimen of wood material, such as a log, stem, wood piece, wooden composite or the like. The characteristic may be for example the stiffness of the specimen, determined by the Modulus of Elasticity (MoE). Alternatively it may be another characteristic such as the velocity of an acoustic wave within the specimen, which in turn can be used to establish a characteristic such as MoE. In broad terms the apparatus 100 may assess or predict one or more characteristics of a tree stem, log or wood piece, or of a wood composite material (herein: sample or specimen) by exposing the sample to a continuous excitation energy which varies at least in frequency over a defined time period, simultaneously detecting the resultant acoustic wave energy in the sample over the same time period via a receiver contacting or in proximity to the sample, and determining the sample characteristic(s) using the detected signal. For slow sweep rates, sweep periods typically near or greater than a second, a low drive power level may be desirable. The consequential acoustic stimulation of the sample is small and linear so that harmonic and intermodulation distortions are minimised. All frequencies are generated uniquely and independently stimulating all resonance frequencies individually. Without limitation, the signal may increase in frequency from 1 Hz up to 200 kHz or above, and for a log may typically be in the range 100 Hz to 20 kHz or 500 Hz to 10 kHz for example. Typically, the sweep time period will be less than 20 seconds, preferably less than 10 seconds, most preferably about 5 seconds or less and greater than 0.1 second, and about 2-3 seconds for example. Processing algorithms interpret the spectral characteristics for the samples acoustic wave propagation effects including absorption and velocity properties and the combination of these propagation effects whilst accounting for other effects.

More particularly the apparatus 100 imparts a varying frequency acoustic wave into the specimen and then detects and analyses the response in the specimen 104 to that acoustic wave to assist in determining the desired characteristic. A controller 101, such as a microcontroller, microprocessor or the like controls operation of a waveform generator 102, DSP 107 and other components of the apparatus as required. The waveform generator 102 generates an excitation signal which is passed to an excitation apparatus 103 including various filters and amplifiers as required and a drive transducer, such as a loudspeaker, roller, piezoelectric element or the like. The transducer is coupled at a first position to the specimen 104 either directly or via a suitable coupling medium to vibrate the specimen 104 in accordance with the excitation signal thereby producing an excitation, for example an acoustic wave, which is imparted into the specimen by way of the coupling. Similarly a receiving sensor 105 is coupled at another position where the response in the specimen 104 to the acoustic wave is detected, and the resulting signal filtered and amplified as required.

This signal is then processed using analogue 106 and/or digital signal processing 107 components to determine the desired characteristic, or a suitable intermediary characteristic 108 or parameter which can be used to ultimately determine the desired characteristic. This characteristic may be determined from a response characteristic 109 which indicates directly or indirectly the acoustic response of the specimen. The response characteristic is derived from a sensed response of the specimen, preferably the receiver sensor 105 signal, which is indicative of the acoustic wave behaviour within the specimen. Preferably, although not essential, the characteristic response can be an acoustic transfer function of the specimen which is derived from the receiver 105 signal and one or more signals indicative of the excitation, for example signals relating to the excitation signal and imparted acoustic wave. To do so the apparatus may further include a sensor in the excitation apparatus 103 in proximity to the driving transducer to detect the acoustic wave output from the transducer. The excitation and acoustic wave signals can be sent to the analogue signal processing components 106 to be processed in the analogue domain 106 as shown, or alternatively could be processed in the digital domain.

It will be appreciated however that a response characteristic could be determined in various other ways. For example the response characteristic may be the receiving sensor signal itself or a derivative thereof. Further in certain circumstances, such as when the excitation transducer 103 is hard coupled to the specimen, the signal from the sensor in the excitation apparatus 103, in addition to providing information indicative of the output of the transducer 103, will also provide a response signal indicative of the acoustic wave behaviour and therefore can be used to derive a response characteristic itself. Similarly an excitation signal used to drive the excitation apparatus may respond to the transducer and therefore exhibit characteristics which indicate the nature of the acoustic wave behaviour in the specimen. To achieve this circuitry in the waveform generator 102 can be implemented to sense the excitation signal. One or more of these signals may be used alone or in combination to determine a response characteristic of the specimen.

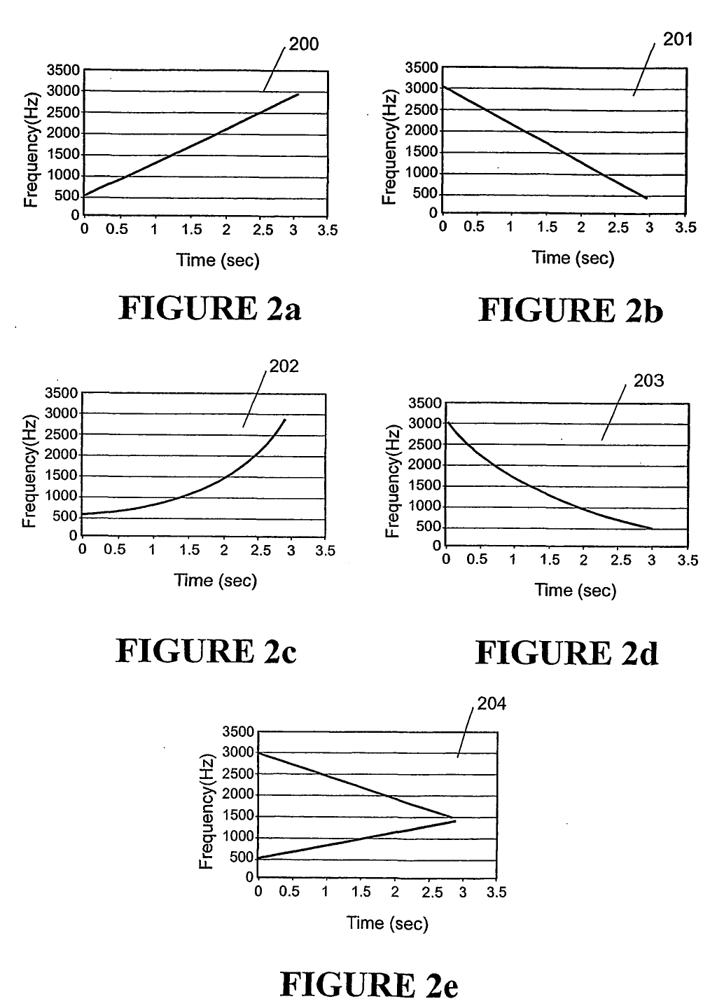

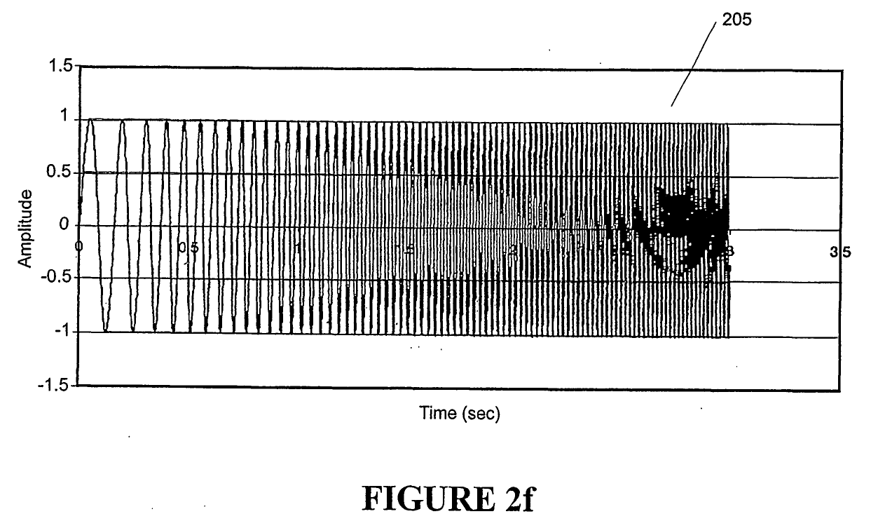

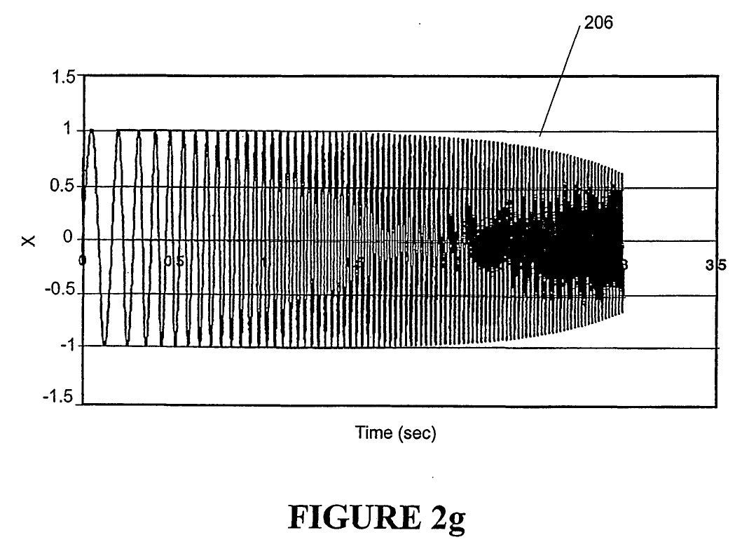

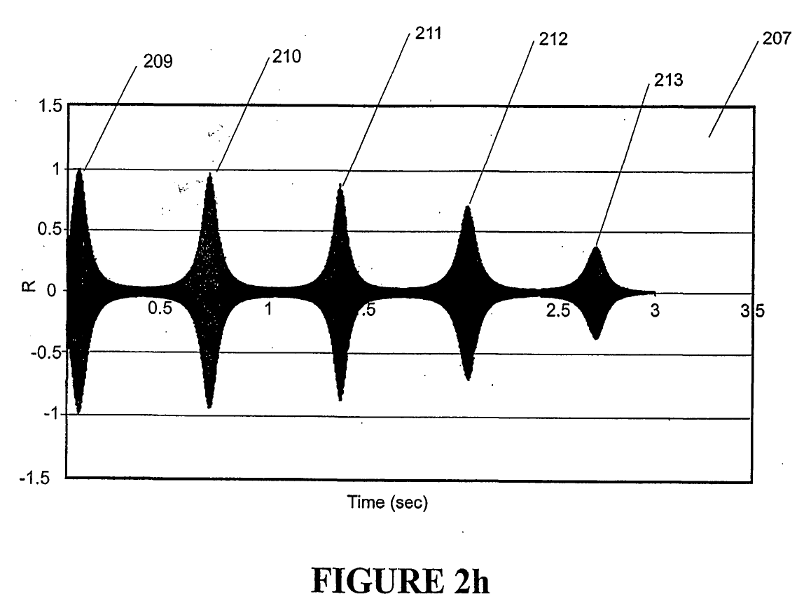

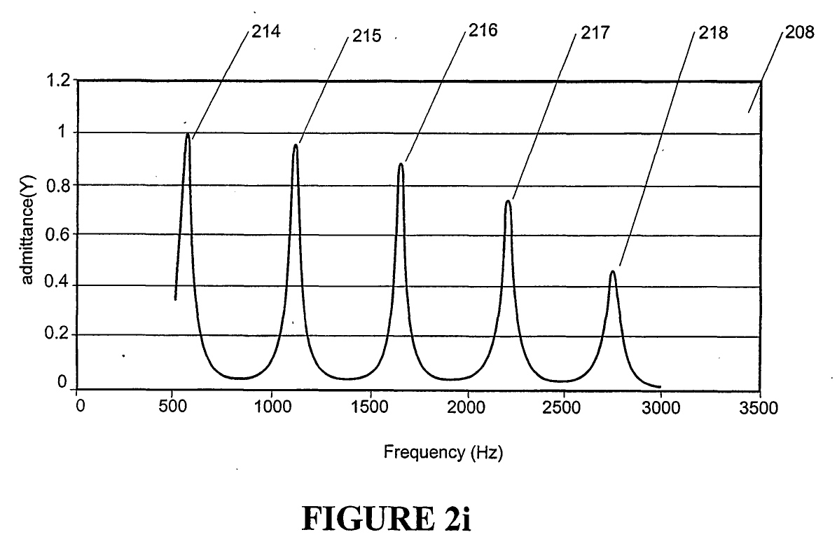

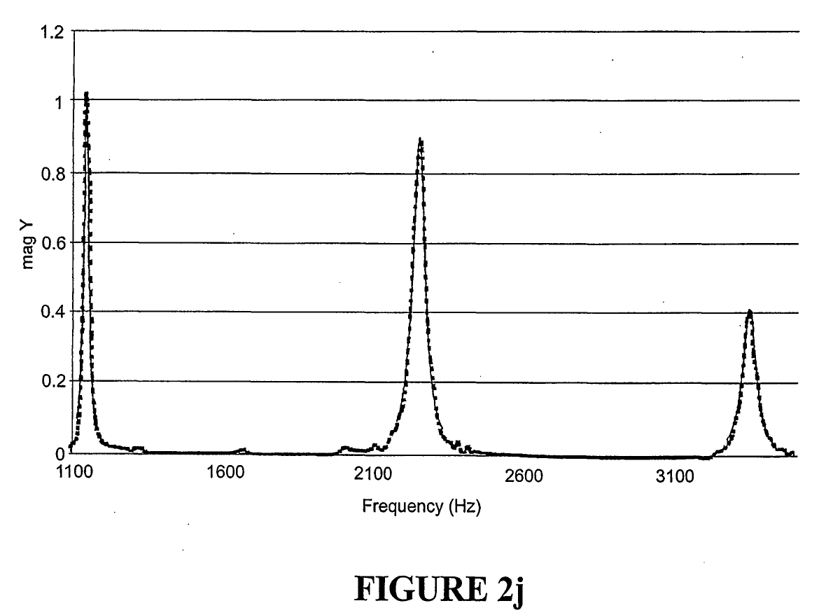

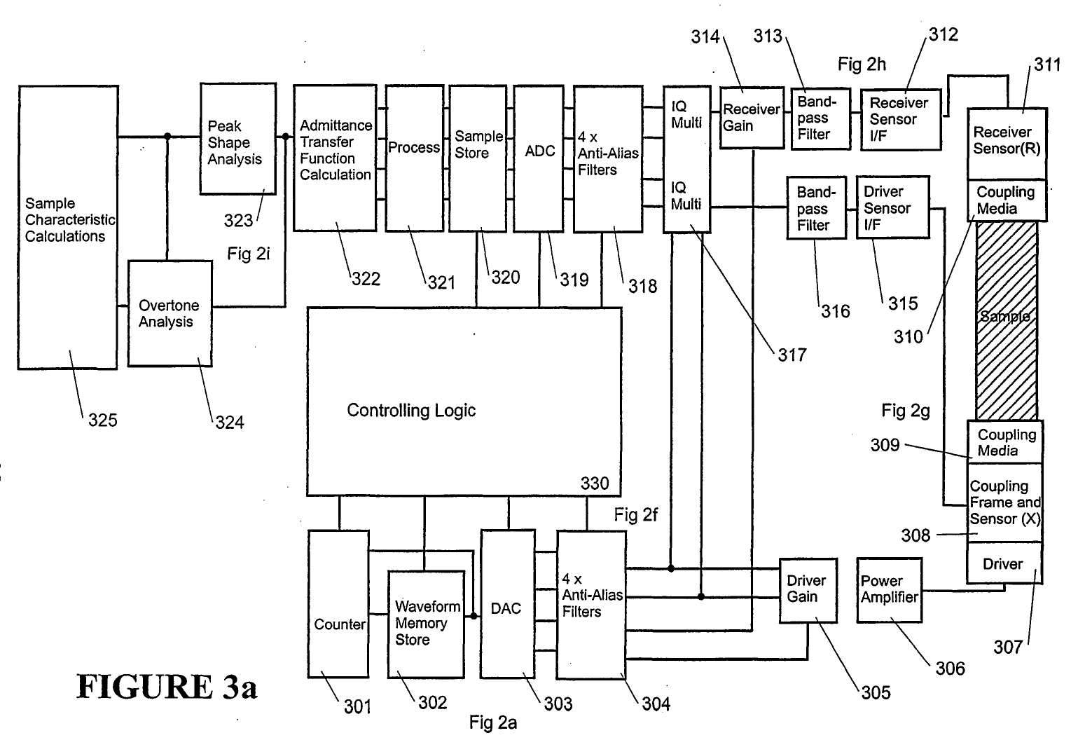

FIGS. 2a-2i show, by way of example, waveforms generated at various points in the apparatus during operation. The frequency varying excitation signal is generated from a sample store in the waveform generator 102. FIGS. 2a-2e show plots of example stored samples which can be used to generate the frequency varying signal. The signal may linearly increase or decrease in frequency as shown in FIGS. 2a and 2b respectively, or may increase or decrease at a linearly increasing or linearly descreasing rate as shown in FIGS. 2c and 2d. Alternatively the excitation signal may be a combination of two or more signals, each of which may increase or decrease, for example as shown in FIG. 2e. It will be appreciated that many other suitable varying frequency excitation signals could be envisaged by somebody skilled in the art and those depicted are not exhaustive. Preferably the frequency is varied in a continuous sweep over a time period at a suitable rate such that a steady state response is reached within the specimen which can be analysed. The frequency varying excitation signal which is used to drive the transducer, causes the transducer to output a frequency varying excitation, for example an acoustic wave. The acoustic wave is then imparted into the specimen although it will be appreciated that this wave may differ from the excitation due to coupling effects and the like. Similarly the acoustic wave in the specimen may differ in nature from the excitation signal due to various responses of components in the apparatus and the response of the specimen.

FIG. 2f shows an excitation signal generated from a sample store such as that shown in FIG. 2a. FIG. 2g shows the detected acoustic wave which is output from the transducer and used to excite the specimen 104. The frequency has been scaled down by a factor of 100 to 5 to 30 Hz in FIGS. 2f and 2g to clearly indicate the phase continuous nature of the sweep. The attenuation visible in FIG. 2g provides an example indication of a possible response characteristic of the driving transducer. FIG. 2h displays the response wave which is set up in the specimen as a result of the acoustic wave stimulus. The resonant frequencies 209-213 of the specimen are apparent in the plot and can be used to assist in determining the desired characteristic of the specimen. FIG. 2i shows a plot of an admittance transfer function in the frequency domain of the specimen which also displays resonance information. It will be appreciated that the excitation signal frequency varies with time and therefore the time domain plots have at least some shape correlation to the equivalent frequency domain plots. Preferably the excitation signal is frequency varying and substantially continuous over a predetermined period over which the analysis is conducted. Further, preferably the indicative response of the acoustic wave behaviour in the specimen is sensed substantially simultaneously to the excitation and over the same predetermined period.

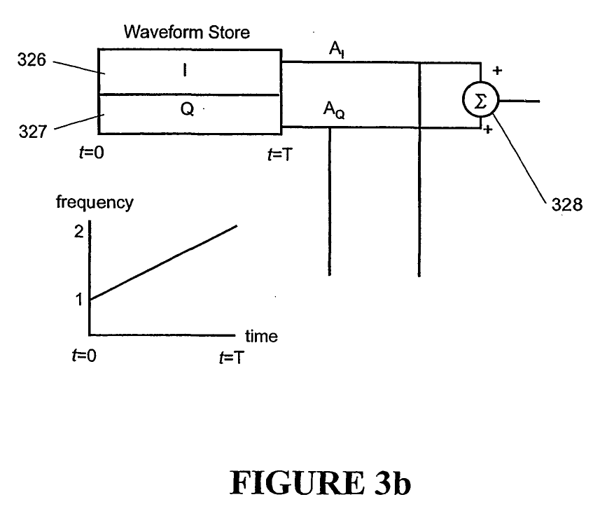

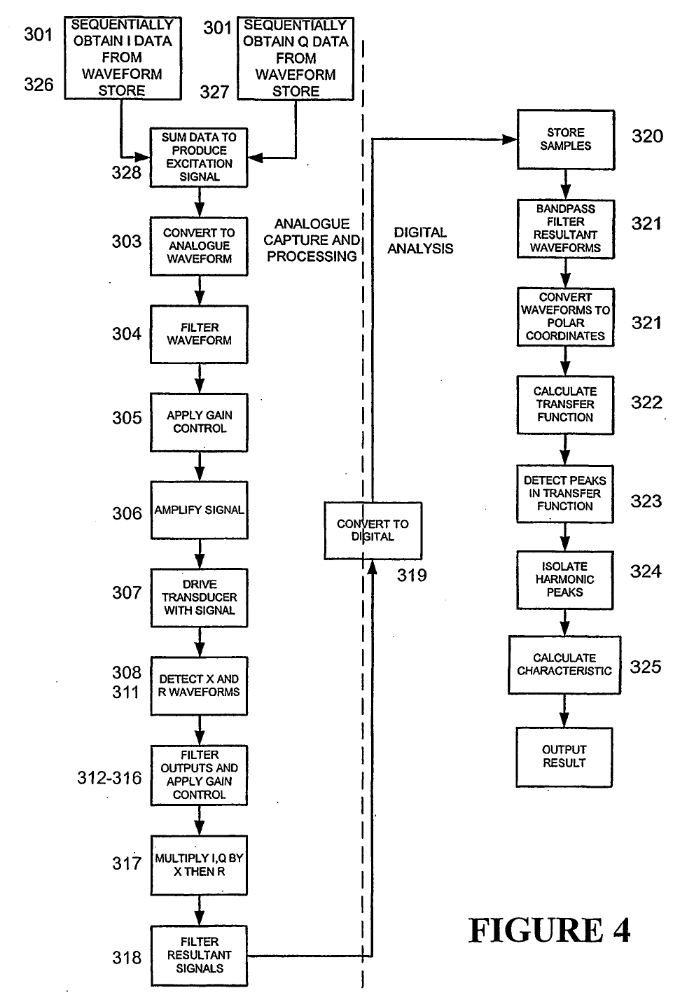

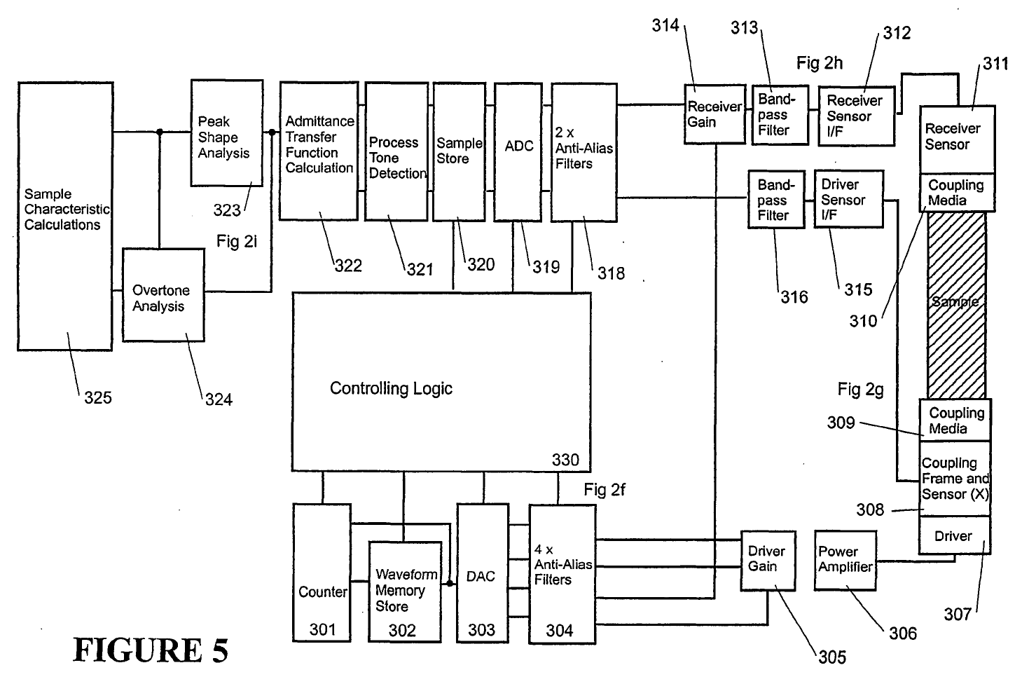

FIGS. 3a and 3b show a preferred form implementation of the apparatus 100 adapted to carry out a three second single tone sweep of a sample over up to around ten octaves. In the embodiment shown the specimen is a log although it will be appreciated that the apparatus can be adapted for other specimen types. As the apparatus described can be adapted for use with a large range of different types of specimens details set forth here may deviate from implementations for other specimen types. For example the sweep frequencies and durations will differ depending on the nature of the specimen being tested. Any such variations will be known to those skilled in the art. Part of the functionality of the apparatus is implemented using various DSPs and other components configured to perform the required signal processing in the digital and/or analogue domain as required. The components along with the function they are configured to carry out will therefore be described with reference to FIGS. 3a and 3b in combination with the flow chart depicted in FIG. 4. FIG. 4 indicates which components shown in FIG. 3 carry out the steps. It will be appreciated that the digital signal processing portions of the apparatus 319-325 may be implemented in any manner known to those skilled in the art, for example on one or more DSPs.

The accompanying diagrams of FIG. 2f-2i are indicative of the waveforms that may be observed at the points indicated in FIG. 3 for a sweep from 500 Hz to 3000 Hz in 3 seconds.

The tone or wave generator 102 of the apparatus 100 includes a counter 301, waveform memory store 302 DAC 303 and antialias filters 304. The samples describing the linear increasing frequency sweep are stored in time sequence in the waveform store 302 before the sweep occurs. FIG. 3b shows further detail of the wave form store along with and example plot of samples stored within, which in this case represents a linearly increasing frequency waveform. FIG. 2f is a representation of the sweep or excitation signal which may result. The frequency has been scaled down by a factor of 100 to 5 to 30 Hz in FIG. 2f to clearly indicate the phase continuous nature of the sweep as mentioned previously.

The graph in FIG. 3b indicates the tone frequency within the waveform store in this case increasing from F₁ to F₂ in T seconds. A single tone sweep with a constant sweep rate [HZ/sec] as shown implies an unequal acoustic wave energy accumulation period across the sweep. At the fundamental for the sample, say 100 reverberations occur in the receiver bandwidth period. Then at the tenth harmonic 1000 reverberations will occur in the same period. This need not be the case; a linear increasing sweep rate (for increasing frequency) implies equal accumulation. In the system shown in FIG. 3a the counter 301 includes sweep time and phase counters. The memory 302 stores one full or multiple period of the sampled I and Q 326, 327 waveform components to be generated, driver and receiver sweep gain control samples plus an instantaneous phase increment value. The result of the phase counter 301 is used to address the waveform memory 302 samples, and is hence the instantaneous phase. The result of the sweep time counter 301 is also used to address the sweep gain samples in the memory 302 and instantaneous phase increment value. At every cycle of the system, about 2 MHz, the waveform memory I and Q samples are combined in a summer 328 and used to update the DAC 303 and analogue output antialias filters 304 to generate the excitation signal 205. The sweep gains are then adjusted, and the instantaneous phase increment value is added by the phase counter 301 to its current value. For a constant phase increment value a single tone will result; for a constant rate of increase of the phase increment value a linear increasing frequency ramp will result as shown in FIG. 2a. A linearly increasing rate in the phase increment value achieves a linear sweep rate as shown in FIG. 2c and hence equal energy accumulation.

The excitation signal 205 is then passed to a drive gain amplifier 305, power amplifier 306 and the output signal passed to the driver 307 such as a loudspeaker or other suitable transducer. The driver 307 is coupled the specimen 104, preferably at one end, via a coupling frame and coupling media 309 which may be air or another suitable acoustic coupling media. Preferably a driver sensor 308 is mounted on the coupling frame either in proximity to or directly on the driver to detect the actual acoustic wave output from the driver 307 which in turn is imparted into the specimen. This sensed wave is indicative of the excitation, ie the output of the driver 307, as well as in certain circumstances providing an indication of the acoustic wave within the specimen. The actual drive amplitude and spectral characteristic may be able to be transduced by the drive accelerometer 308 mounted on the coupling frame. The drive forcing function can be inferred from the acceleration waveform. In this circumstance the drive level can be adjusted instantaneously or sweep-to-sweep by the driver gain stage 305 to achieve the desired excitation drive amplitude from the power amplifier 306 and driver 307 whilst limiting peak resonance amplitudes. This method compensates for any broad spectral characteristics, for example a roll off of the driver with frequency, and best preserves the dynamic range of the overall system. Residual drive spectral characteristics are recorded in the drive waveform.

A receiver sensor 311 such as an accelerometer is also mounted on the sample using a suitable coupling media 310 so that sample vibrations are fully coupled to the receiver. For sinusoidal waveforms sample velocity and displacements can be calculated from the receiver output. The output of the receiver sensor 311 is indicative of the acoustic wave behaviour in the specimen. A representation 206 of a possible excitation recorded at the driver sensor X 308 is indicated by FIG. 2g and a possible sample response 207 recorded by the receiver sensor R 311 is indicated in FIG. 2h. A plot 208 of the resulting magnitude of the transfer function, in this case admittance, is indicated by FIG. 2i. It should be noted that the graph indicates the function in frequency space. Translating between time and frequency is a consequence of the sweep frequency definition in time as mentioned previously. The receiver signal is amplified 312 and band pass limited 313 to the sweep bandwidth, amplified 314 and applied to multipliers 317 enabling the complex receive signal to be synchronously detected. More particularly the receive signal 207 is multiplied by the I and Q components of the excitation signal 205 respectively using analogue multipliers. The resultant signals are filtered using antialias filters 318 to extract the receiver signal 207.

The multiplied and filtered receive 207 waveform is then sampled by an ADC 319 and stored in a sample store 320. A range of signal processing is then carried out by a DSP 321 including bandpass filtering and normalisation of the stored waveforms, low pass filtering and conversion of the results between vector and polar coordinates. The multipliers provide a down converter function enabling a wideband excitation with low sample rate ADC converters 319 and to limit the sample store 320 size and subsequent data processing. It has been found that for very small samples excitation frequencies up to 200 kHz can be desirable. It has also been found that a receiver bandwidth, set by the low pass filter corner frequency implemented in the DSP 321, of about 100 Hz provides adequate electronic resolution to enable-measurement of typical wood samples of length less than around 0.3 metre i.e. the low Q of the wood samples implies a reverberation bandwidth significantly greater than that of the receiver bandwidth. This receiver bandwidth is implemented in firstly the analogue antialias filters 318 and then subsequently in the DSP 321. Narrower receiver bandwidths, which may be desirable for longer sample lengths, are then conveniently achieved in the digital domain; a bandwidth of typically less than 10 Hz would be used for logs of several metres length.

The driver sensor signal 206 is similarly amplified 315 and band pass limited 316 to the sweep bandwidth, multiplied 317, filtered 318 and detected in identical fashion to that of the receiver waveform 207. The multiplied and filtered sensor 207 waveform is then sampled by an ADC 319 and stored in a sample store 320. A range of signal processing is then carried out by a DSP 321 including bandpass filtering and normalisation of the stored waveforms, low pass filtering and conversion of the results between vector and polar coordinates. The drive bandwidth is achieved identically to that of the receiver. The channels are identical except in the sensing function and that the receiver channel incorporates an additional gain function 314 identical to that incorporated in the driver output i.e. the receiver stage gain can be adjusted instantaneously or sweep-to-sweep to achieve the desired detection amplitude. The receiver signal 207 and the actual drive signal 206 are detected synchronously by the excitation signal 205 ie the measurements occur simultaneously with the excitation, and further the excitation extends for the entire measurement period. A plot of the magnitude term alone is the usual representation of the processed X and R waveform functions i.e. the magnitude of R determined in this way represents the magnitude of the received sensor signal sine wave 207 and similarly the magnitude of X determined in this way represents the magnitude of the sensed acoustic wave signal 206. Timing is achieved through the use of controller 330. For suitably sized samples i.e. logs or stems with a diameter say greater than 50 mm, the measurement can be single ended i.e. the driver and receiver may be located at the same end.

Once the samples have been processed a response characteristic is produced using a transfer function calculator 322. In the preferred embodiment an admittance transfer function 208 is produced although it will be appreciated an impedance transfer function could be obtained. To find the transfer function the sample or specimen can be modelled as a number of mechanical resonant filters stimulated by the drive forcing function in a manner known to those skilled in the art. The complex mechanical impedance Zm, defined as the ratio of driving force F to the resultant acoustic wave velocity v at the particular driving frequency is
Zm=F/v (1)
which has a small real amplitude when the drive frequency is coincident to a mechanical resonant filter frequency, and consequently the instantaneous power transferred from the drive to the sample is high—large vibration amplitudes result. Similarly when the drive frequency is not at a mechanical filter resonant frequency the mechanical impedance is high [includes reactive terms], the instantaneous power transferred between the drive and sample is low and low vibration amplitudes result. This system measures waveforms closely approximating the forcing function and resultant vibration velocity. By determining the receiver and drive waveform ratio the sample admittance Y may be approximated at the particular drive frequency since
Y=1/Z=v/F (2)
For a sweep, determining the admittance throughout the frequency sweep determines the sample admittance transfer function spectrum 208. Admittance is a less commonly used concept however in this instance more intuitive. At resonance admittance peaks, high velocity amplitudes result for a constant driving force, the velocity being in phase with the applied force. Further by measuring the in phase and quadrature components of these complex waveforms the real and reactive components are identified, and a precise measure of each resonant frequency determined. For such sweep rates the spectral characteristic is “time invariant” since the stimulating drive is effectively constant i.e. the receiver waveform at all frequencies is a consequence of many transits of the acoustic wave and consequently measures the plane wave response. Slow sweep rates do not impart an envelope function on the resonance characteristic in wood samples and therefore the admittance can directly provide the spectral transfer function of the sample i.e. it does not require subsequent transformation or spectral modification. The relative resonance peak amplitudes and resonance peak shapes [Q] reflect the acoustic absorption effects within the sample. In some instances the samples spectral characteristic is approximated, to a first order, by examining the receiver waveform amplitude 207. For loosely coupled constant amplitude spectrally flat drive the receiver response amplitude will exhibit peaks at the sample's resonances eg 209-213 in FIG. 2h. In a preferred embodiment however the actual admittance transfer function 208 is obtained. This done by finding the ratio between the receive waveform 207 and the sensor waveform 206 which are synchronously detected. This ratio relates to an approximation of the admittance function in defined in equation 2. The admittance measure can be thought of, in a limited way, as an extension of this first order system whereby it is enhanced to accounting for the driver 307 spectral characteristic i.e. the receiver amplitude response may be normalised by dividing it by the driver 307 amplitude response. In doing so residual spectral characteristics in the driver response 307 are removed.

Unlike the transit time and resonance measures this method ensures that all frequencies are stimulated and that noise is less of a concern. Hence it is not uncommon for logs of length l metre or greater to clearly distinguish overtones up to and beyond the tenth harmonic. The low inherent noise is a consequence of the sweep drive method. The acoustic wave energy effectively integrates within the log within the receiver bandwidth period. For example for a log of length 2 metres a sweep may start at say 500 Hz and stop at 10 kHz (10th overtone) and with a single tone occur over say a 3 second period. Then for a receiver bandwidth of 100 Hz the energy accumulation period is 32 milliseconds, for all frequencies individually in the sweep. Identical, precise stimulus even to high input energy levels can very easily be attained. This has to be compared to the energy input period of the hammer methods. One would expect the hammer hit induced stress wave for such a log to occur with a period consistent with the swept bandwidth i.e. 2 milliseconds to 0.1 milliseconds, for all frequencies simultaneously. The greater the energy accumulation period the greater certainty in the result. The sampling rate and the sweep definitions determine the actual spectral resolution. In the system described 8192 samples are collected in a 3 second sweep i.e. approximately 3 Hz sample resolution in the 2 metre log example.

The resonance peak shape and amplitude of the receiver signal 207 and admittance transfer function 208 reflect the acoustic phenomena within the sample. One of the resonances, preferably the fundamental can then be used to find the velocity of an acoustic wave in the specimen 104, and then the velocity used to find the MoE. To extract the resonances the digital signal processing portion of the apparatus further includes a peak shape analyser 323 which determines peaks which correspond to a desired shape, overtone analyser 324 which determines related harmonics and characteristic calculator 325 which determines acoustic velocity and MoE. The resonance extraction process will described in relation to the admittance transfer function however it could be applied to the receiver signal 207 if required. Algorithms implemented in these components identify the peak shape and overtones sequences in the sample admittance transfer function spectrum. These alogorithms find a resonance from the transfer function 208 firstly identifying peaks in the response characteristic which exceed a magnitude threshold, have a shape which substantially correspond to a general resonance model within a predetermined level of fit, and have a Q which falls within a predetermined range. these peaks are then analysed to identify those groups of peaks which have centre frequencies which substantially correspond with known resonant behaviour of the sample and then to identify the group of peaks which best correspond with the known resonant behaviour. Once the group of peaks are identified, which are assumed to correspond to resonances, one or more of the peaks are used to calculate a resonant frequency, preferably the fundamental. Preferably the fundamental is found by analysing most or all the peaks in the identified group.

More particularly, peaks are individually analysed by correlation or other means to ascertain the best shape factor and degree of fit with known predetermined peak shapes. Appropriate predetermined shapes would be those derived from the general resonance Q equations known to those skilled in the art, which have a form

$$Q = \frac{fr}{fb}$$

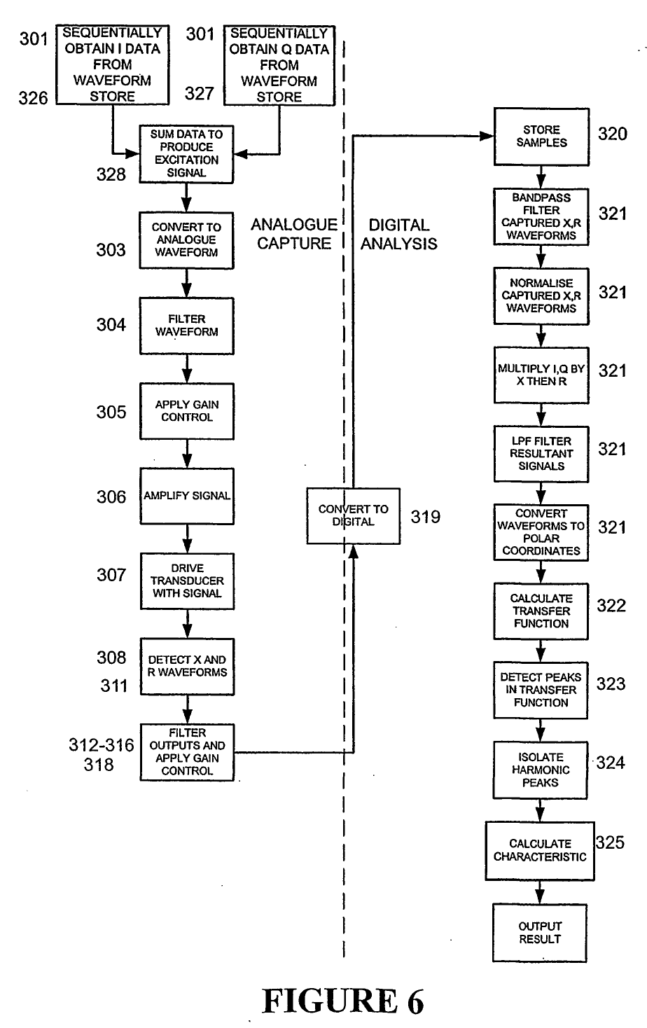

such as that shown in FIG. 2j, where fr is the resonance frequency and fb is the resonance bandwidth. Resonance peaks that are either insufficient in relative magnitude or exhibit a poor degree of fit or have a shape factor which is unacceptable, for instance an apparent Q say less than 5 or greater than 500, are rejected. FIG. 2j is the first three peaks of the 2.2 m log of FIG. 6. The measured data is shown as the dotted line. Overlying the three peaks is a solid line being the expected form of the peaks from the general resonance equations with the same Q value applying at each peak in this instance. The fit is clearly acceptable. It is to be expected that successive overtones of a sample response will have similar shape factors for similar magnitudes and that the shape factor will trend with the overtone number consistent with absorption phenomena that generally increases as the square of the frequency for viscous damping for instance. It is by these means that interference signals are firstly rejected. The resonance frequency of the overtones can also be expected to trend with the overtone number and not necessarily be harmonic. Sweeping a sample over a ten harmonic range implies a possible absorption range of two orders of magnitude. Consequently, especially for small samples say with fundamental frequencies exceeding 10 kHz, dispersion may be evident in the overtone resonance frequency sequence dependent on the magnitude of the absorption. This effect is distinguishable from sample loading effects since dispersion effects due to damping correlate with the peak shape factor and also by the nature of the relationship with frequency. In all circumstances the actual fundamental is determined by iteration. Each resonance peak is individually tested with each other peak for consistency with the relationships defining the fundamental and overtone frequencies for the above effects.

By way of example consider a harmonic sequence of overtones with an additional interference signal at one half the fundamental. By simply matching the interference signal without regard to the expected relationship, in this instance fn=n*f₀ a supposed perfect match is achieved since the harmonic sequence appears as the even harmonics of the interference, an incorrect velocity could be attained. It will be appreciated by those skilled in the art that other relationships between the fundamental and harmonics may be displayed by specimens. For example where a specimen has a large width or diameter in relation to its length, the harmonic relationship may not be an integer multiple. By testing each peak with each other peak using the expected relationships the interference and harmonic sequences can be differentiated, an error occurs for missing or misidentified peaks. The sequence that maximises the number of admittance peaks accounted for and minimises the number of errors is accepted as the harmonic sequence. For example, the sequence or group of peaks which have the greatest combined amplitude are selected as the resonant peaks of the specimen. The fundamental frequency can then be determined, or alternatively one of the other harmonics. Preferably however the fundamental is determined using most or all of the detected harmonics. Incorporating the overtones enhances the precision to which the fundamental is determined since having identified the sequence the fundamental may be calculated as the average of the calculated value determined for each overtone existing in the sequence. From the fundamental f and knowing the sample length l the acoustic velocity v is calculated in the characteristic calculator 325 according to:
V=2fl
From the acoustic velocity the modulus of elasticity MOE may be determined using the standard formulation, for a known density p
MOE=pv²
or other suitable means.

In some instances it is preferable but not essential to implement a modified detector scheme as shown in FIG. 5. The components along with the function they are configured to carry out will therefore be described with reference to FIGS. 5a and 3b in combination with the flow chart depicted in FIG. 6 which indicates the components shown in FIG. 3 that carry out the steps. In this implementation both the drive 206 and receiver 207 waveforms are simultaneously digitised directly by the ADC 319 and the individual components detected digitally. This is possible since the waveform generator 301-304 and analogue converters are synchronised enabling sample by sample evaluation of the drive 206 and receiver 207 outputs. FIG. 6 indicates the time sequence of operations for this alternative embodiment using a single tone sweep. In this instance the system comprises two processes, a stimulus and data capture process and a subsequent analysis process. The samples describing the sweep are stored in a time sequence in the in phase (I) and quadrature (Q) buffers 326, 327 shown in FIG. 3b before the sweep occurs. The graph in FIG. 3b indicates the tone frequency within the waveform store in this case increasing from F₁ to F₂ in T seconds. During the sweep the waveform samples are added and then output to the DAC 303 in the time sequence and filtered 304. Drive amplitude control 305, 306 may be applied as previously described to generate the stimulus waveform. The driver sensor (X) 206 and receiver sensor (R) 207 waveforms are filtered 315, 316 and 312-314 respectively, gain amplitude controlled 314 as previously described, converted by the ADC 319 and recorded in the sample store 320 in time sequence. On the completion of the sweep the waveform and sample store are subsequently used by the processing and analysis routines implemented in the digital signal processing components 321-325. The X and R waveforms 206, 207 are band pass filtered and normalised in amplitude by routines implemented in the DSP 321 before presentation to the tone detection stage. In this implementation the tone detection is achieved by a digital multiply and low pass filter method which are also implemented in the DSP 321. The waveform store 326 I data is multiplied with the sample store 320 X data in the time sequence and the result stored in an intermediate product buffer in the DSP 321. This is repeated for the waveform store 327 Q data on the sample store 320 X data, and also both I and Q data on the sample store 320 R data. The intermediate product buffers comprise frequencies (A+B) and (A−B) for each frequency in the sensor waveform since the product of two sine waves is given by:
sinA*sinB=sinA(A+B)+sin(A−B)
The unwanted frequencies are rejected by filtering the intermediate buffer product with a low pass filter leaving (A−B) implemented in the DSP 321 which in this instance for low sweep rates is close to dc. The bandwidth of the filter is set as suggested earlier, about or less than 100 Hz for sample lengths less than 0.3 m and less than 10 Hz for samples several metres long. The resulting complex X and R waveforms then describe a bandwidth limited version of the sample store 320, the bandwidth being the low pass filter bandwidth with the center frequency of the filter at any instantaneous point in time being the original waveform store frequency i.e. the stimulus 205. The waveforms are converted by a routine in the DSP 321 to a polar form for convenience, a plot of the magnitude term alone being the usual representation of the processed X and R waveform functions i.e. the magnitude of R determined in this way represents the magnitude of the received sensor signal sine wave 207 and similarly the magnitude of X determined in this way represents the magnitude of the sensed acoustic wave signal 206. The admittance transfer function for the sample is calculated as previously described, for slow sweep rates this measurement outcome directly provides the spectral transfer function of the sample. The admittance transfer function peaks reflect the resonance and absorption phenomena occurring within the sample. The resonance peaks are detected using the peak analyser 323 from other effects based on the apparent Q and degree of fit to the Q curve as discussed previously. The centre frequency of peaks meeting the criteria is then used by the overtone analyser 324 to determine a fundamental resonance frequency from which the acoustic velocity is calculated.

The alternative embodiment of the apparatus shown in FIGS. 5 and 6 can be modified to impart multitone or arbitrary compression drive of the sample. For example, a multitone acoustic wave can be generated from stored samples such as that shown in FIG. 2e in which two or more varying frequency acoustic waves are substantially simultaneously imparted into the specimen 104. This facilitates a major reduction in the sweep period, preserving the receiver bandwidth, energy integration effects and spectral resolution. This is especially desirable in the testing of sooks for instance, the short 100×50 mm or similar lengths used in finger jointing where throughput is high. In the above 3 second single tone sweeps over 10 overtones have been given as an example. Since the system is linear with small amplitudes tones can be superimposed. For example, the sweep could consist of a tonal sequence comprising a fundamental fₒ acoustic wave superimposed with both 2.2*fₒ and 4.84*fₒ acoustic waves for a linear sweep rate. Then the total sweep period equivalent to the single 3 second single tone linear sweep fₒ to 10*fₒ is 0.4 seconds. The tonal sequence is recorded in the waveform memory and operates as previously described. This sequence was chosen to avoid the simultaneous occurrence of harmonic overtones thereby minimising harmonic distortion effects and the possibility of harmonically related large combined vibration amplitudes. Other sequences could be used in preference. If a harmonic sequence is used then the equivalent total sweep period can be reduced to 0.3 seconds. It can be advantageous to utilise say six tones or more. As the number of tones approaches or exceeds the number of octaves spanned the sequence is more easily chosen to be nonharmonic.

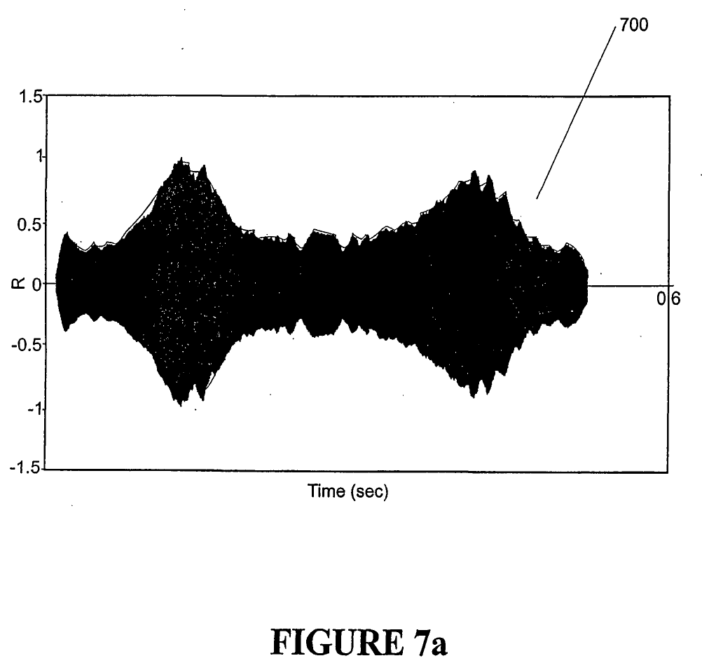

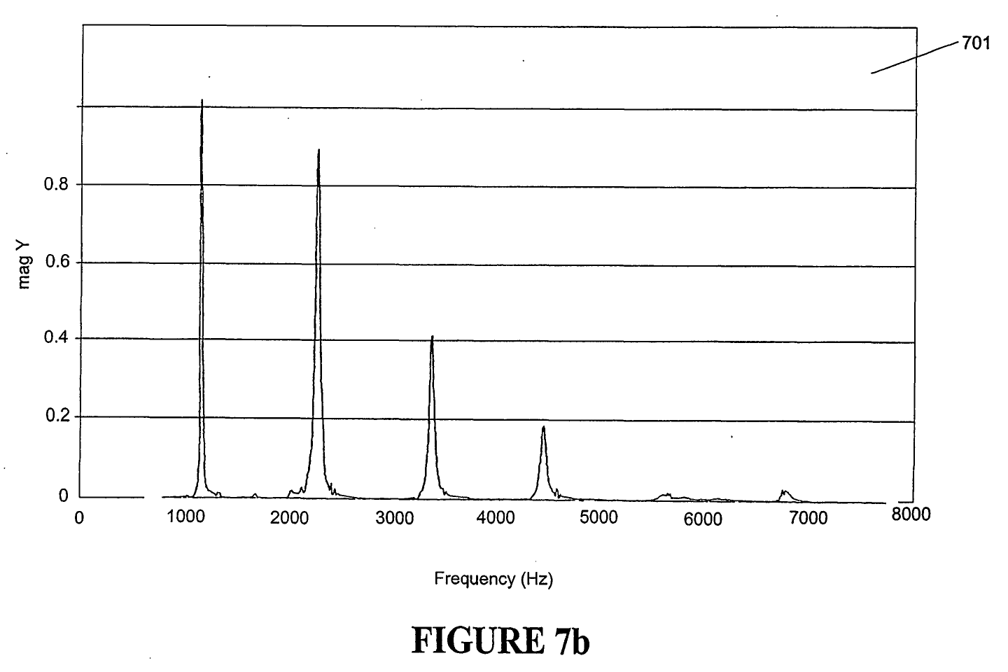

When viewed in the time domain the resultant waveform 700, for example as shown in FIG. 7a, looks increasingly noise like. This is not in fact the case, the waveforms must be interpreted by a synchronous detection system as described previously, for example in relation to FIGS. 5 and 6. In particular, the synchronous detection extracts resonance peaks from the output waveform 700 relating to the resonances setup in the specimen in response to each of the component acoustic waves which were imparted. That the time domain waveforms look this way is of great significance. A stress wave hit waveform imparts energy to the sample at the hit only, which by necessity must be a very small fraction of the measurement period. For a swept drive system energy transfer occurs whenever the samples admittance allows, at each overtone. For a complementary multitone sweep, ie an increasing and decreasing frequency for each tone, nonharmonic multitone stimulus waveform energy couples to the sample substantially constantly throughout the measurement period. FIGS. 7a and 7b show plots 700, 701 for a log of length 2.2 metres for a swept frequency range 500 Hz to 7000 Hz for 0.5 seconds with a complementary 12 tone multitone sequence exciting the sample. FIG. 7a shows the receiver sensor time trace which unless observed by a synchronous detection system is difficult to interpret. However the magnitude plot 701 indicated is similar to that of the peaks in FIG. 2h and FIG. 2j, the points of maximum energy transfer and signal. The plot 701 in FIG. 7b is the admittance transfer function spectrum. On average the tones are only 270 Hz apart spanning 541 Hz, with a resonance bandwidth of about 50 Hz. As can be observed in the time trace energy coupling occurs at all times during the entire sweep period.

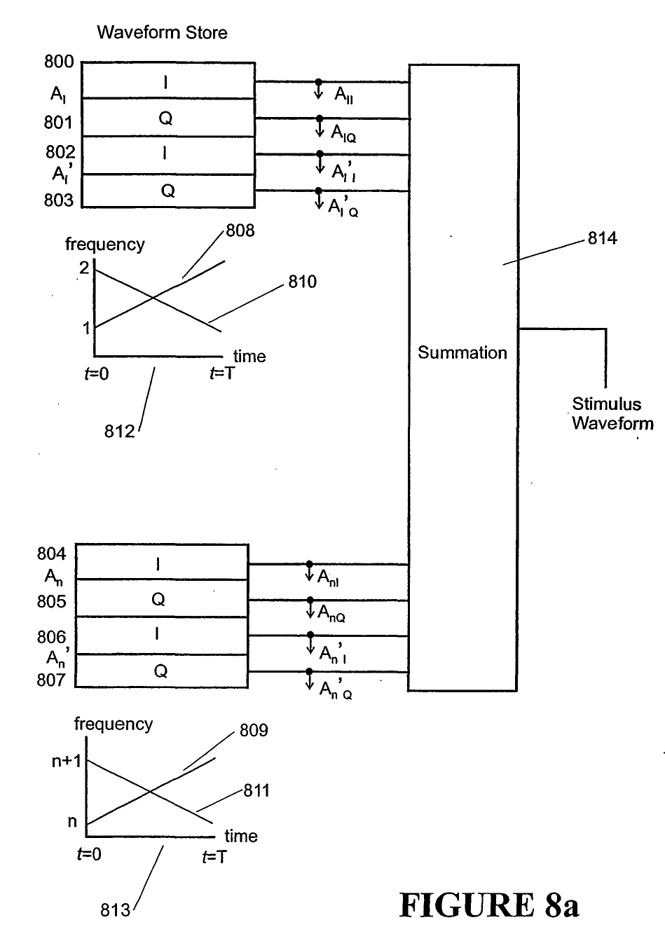

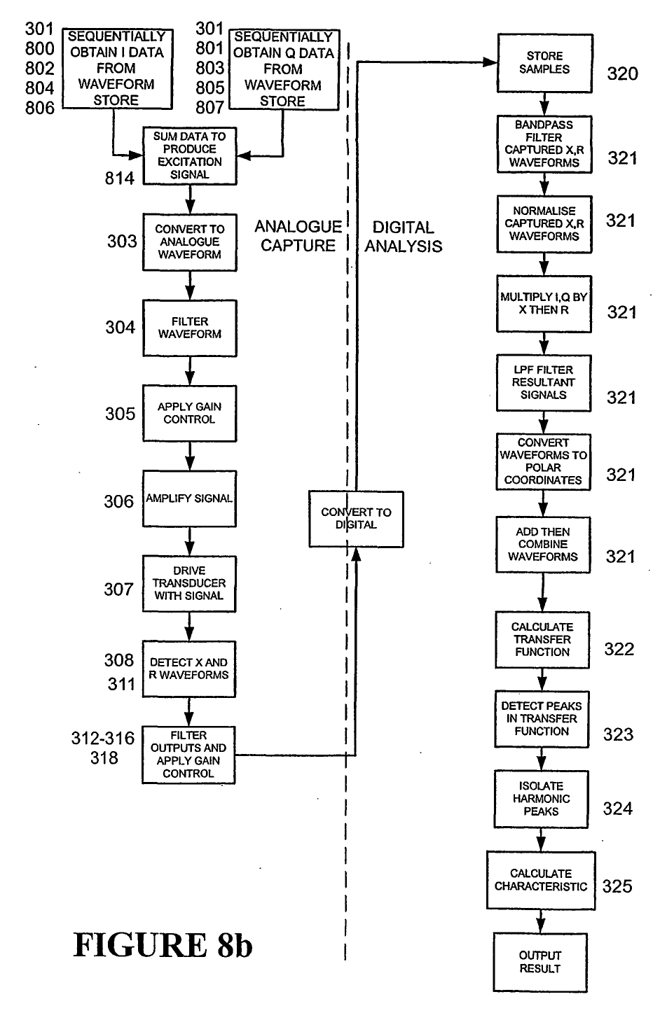

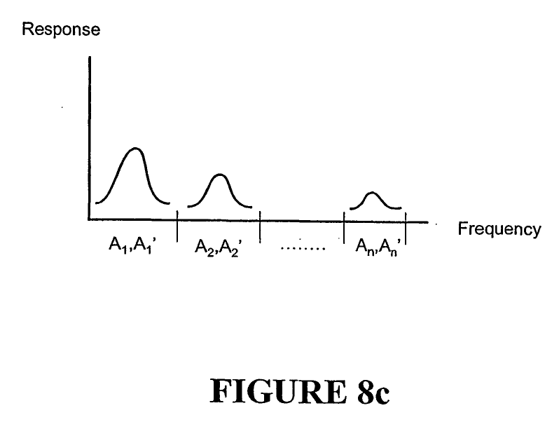

FIGS. 8a and 8b show block diagram and a corresponding flow chart of an embodiment which expands the single tone system of FIG. 5 to facilitate multitone drive. The waveform store 302 is extended to include I and Q component sample stores A₁ₗ, A_{1Q}, A_{1′I}, A_{1′Q} 800-803 to Aₙ₁, A_{nQ, A}_{n′1}, A_{n′Q} 804-807 for each additional tone added. FIG. 8a shows two plots 812, 813 showing a matching increasing Aₓ 808, 809 and decreasing Aₓ′ 810, 811 frequency respectively for each of the tones of the multitone. The graphs 812, 813 indicate the tone frequency at the point in time within the waveform store 302. Note that in this example tone 1 spans from frequency 1 to 2 and that tone n spans from frequency n to n+1. The waveform store samples 800-807 are summed 814 as before to form the stimulus waveform. Each of the tones of the multitone may be detected in similar fashion to that of the single tone sweep as indicated in FIG. 5b, individually the I and Q of each of the tones of the waveform store are multiplied and low pass filtered by the X and R waveforms. The complementary increasing and decreasing complex resultant X and R waveforms are combined during the conversion for each tone. An expanded buffer is formed by sequentially recombining the overlapped time multitone into a nonoverlapped concatenated frequency axis as shown in the graph in FIG. 8c.

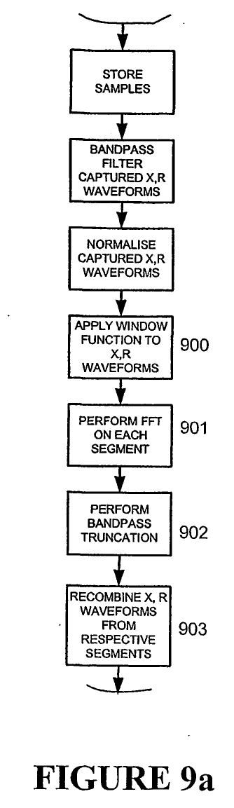

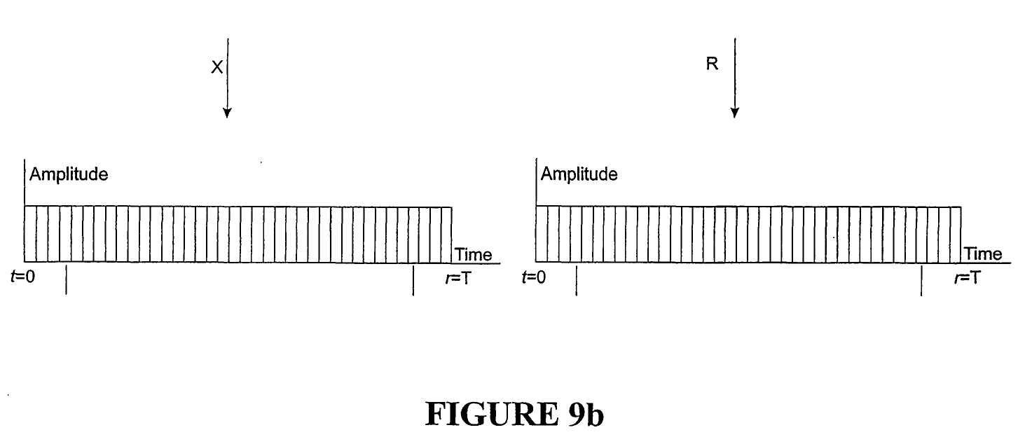

Whilst the multiplier/low pass filter method of tone detection provides excellent detection and rejection performance and preserves the complex X and R waveforms it does require significant computational effort since each tone must be processed individually for the duration of the sweep period. FIG. 9a shows a portion of an alternative process undertaken by the DSP 321 where detection of tones occurs in parallel in the frequency domain, the remaining steps not shown being the same as described previously. FIG. 9b show a corresponding representation of the segmentation scheme. In normal use this can achieve a good compromise between spectral performance and computational speed, however phase information would usually be lost. Referring to FIG. 9a the X and R waveforms are detected and band pass filtered and normalised as before. A segmented FFT algorithm is then implemented in the DSP 321 wherein the sample store buffer period 901 (visible in FIG. 8b), is divided into a number of equal time width samples, for example 32. Each of these is windowed 900 and Fourier analyzed 901 as a part of the segmented transform. Usually for a segmented transform the spectrum outcome is then recombined by summation 903 of each of the individual transforms since the outcome power spectral density is the combination irrespective of the time sequence sample. If however the resulting frequency space for each sample is truncated in such a way that it only contains data corresponding to frequencies spanned by the waveform store in the same time period then a quantised tracking filter function is achieved. Multitone signals may be processed in parallel in the frequency domain by appropriate truncation of the sample transform using a bandpass truncation algorithm 902.

The resulting waveform is then processed in the usual way by calculating the transfer function, determining the peaks, detecting the harmonics and calculating the characteristic. As is sometimes done in segmented Fourier analysis, an additional set of samples offset by one half of the sample width is also analyzed, ie windowed, FFT, frequency truncated and summed into the resulting outcome. In this way the effect of the window function is diminished. For a six tone sweep over 5 octaves using a overlapped segmented transform as above the resulting bandwidth is equivalent to that stated above i.e. about or less than 100 Hz for length 0.3 m or less than 10 Hz for samples of several metres length.

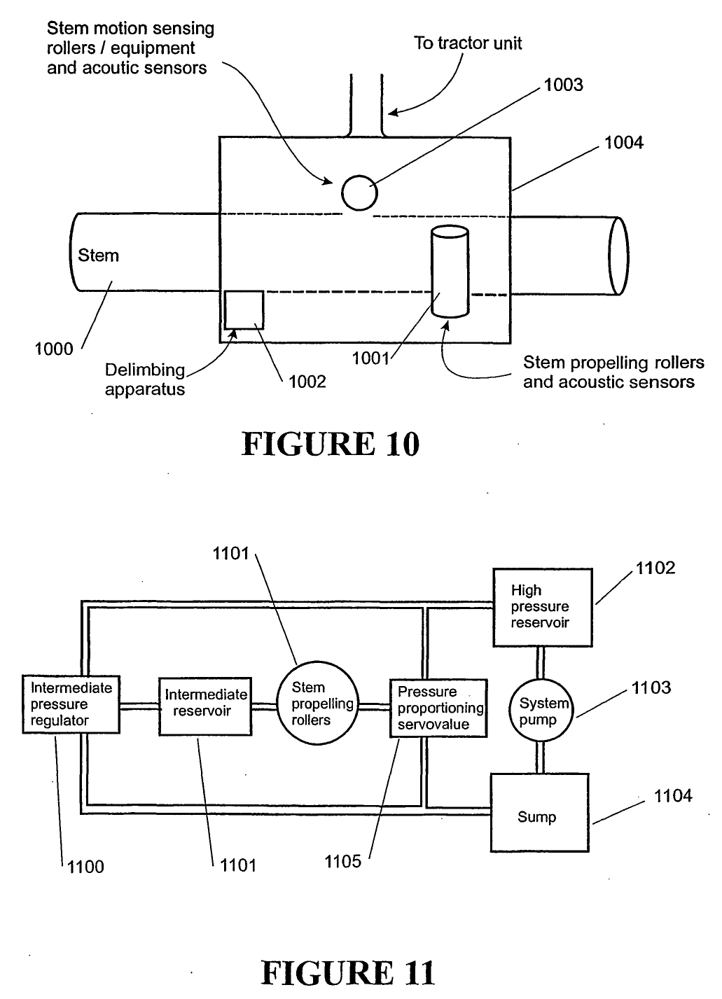

Implementations of the apparatus will now be described with reference to FIGS. 10-15. FIG. 10 indicates a means 1004 by which tree stems 1000 may be measured during harvesting. It is common practice for trees to be felled, delimbed and cut into logs by a log harvester which typcially cromprises a digger tractor unit with log harvester head 1004 attached to its boom. The head 1004 utilises one or more hydraulic motor driven rollers 1001 (of which one is visible) to propel the stem through the head and to remove branches and the like from the stem by way of a delimbing apparatus 1002. A stem motion roller 1003 can detect movement of the stem to establish various parameters such as stem length. To implement the present invention in such an apparatus the rollers 1001 can be adapted to impart an acoustic wave into the stem 1000 by oscillating the stem longitudinally using. Usually stems are longer than 25 metres long hence the swept frequency range is preferably from say 20 Hz to 400 Hz (6^{th} overtone) for typical acoustic velocities. This is within the useful frequency range of servovalves which control the hydraulic rollers 1001. FIG. 11 includes a simplified hydraulic circuit which could be operated in a manner to drive one of the hydraulic roller such that it oscillates the stem 1000. The stem propelling rollers 1001 spaced around the stem are driven by bi-directional hydraulic motors. A system pump 1103 channels hydraulic fluid from a sump 1104 to a high pressure reservoir 1102. The high pressure hydraulic fluid is used to rotate the roller 1001 in a controlled manner by way of a pressure proportioning servovalve 1105. The left port of the motor is maintained at an intermediate pressure, about one half of the high pressure feed from the high pressure reservoir 1102, by a pressure regulating system including an intermediate pressure regulator 1100 and intermediate reservoir 1101 which can both source and sink flow. The stem 1000 may be propelled through the head by a control system which sets the pressure proportioning servovalve 1105 so that the right port of the hydraulic motor is say at high pressure to drive the stem in one direction or to sump 1104 pressure to drive the stem 1001 in the other direction. Alternatively an acoustic wave of known frequency can be imparted within the stem by modulating the pressure portioning servovalve 1105 with the desired frequency and amplitude. Stem motion is detected by the idler rollers 1103 and independent sensors (not shown) which may be in the rollers 1103, or coupled in another manner to the stem 1000. The swept drive method facilitates a means by which the existing harvesting system can be utilised to implement the invention by imparting acoustic energy into the stem by the circumferential propelling rollers over a period of time, for example three seconds. The narrow bandwidth detection system described previously can be used to eliminate nonlinear responses, extraneous vibrations or other interferences.

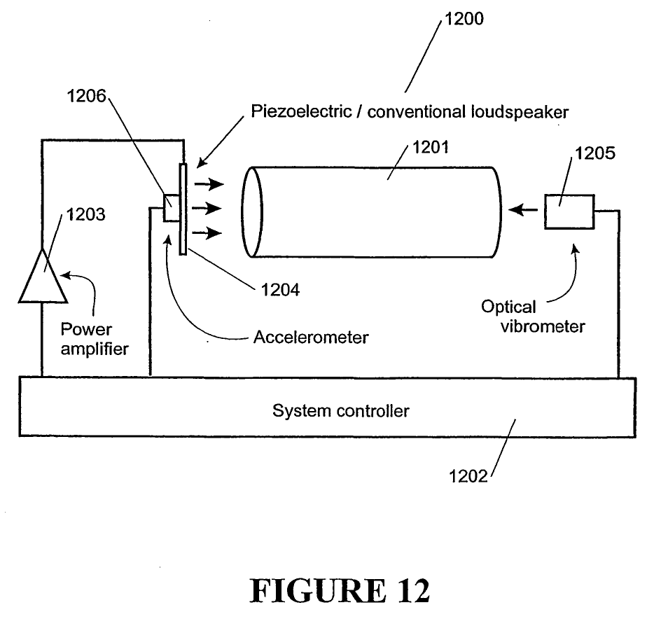

FIG. 12 indicates an implementation used for the testing of bolts, sooks, ASTM samples and the like. These samples are usually small and therefore direct mechanical coupling of a driver and in some instances a receiver may influence the acoustic properties. A transducer 1204 such as a piezoelectric or conventional loudspeaker is air coupled to the specimen 1201 and is driven by an excitation signal which is passed through a power amplifier 1203. An accelerometer 1206 is attached to the transducer 1204 to detect the acoustic wave output by the transducer. An optical vibrometer 1205 measures response to the acoustic wave which is imparted into the specimen 1201. A system controller 1202 contains the functionality required to operate the system as described previously. The swept system can provide reliable data with low level acoustic excitation, typical of air coupled systems. This is a consequence of the energy accumulation within the sample in a given bandwidth period coupled with narrow band detection. The use of multitone stimulus enhances the signal level by effectively extending the accumulation period in proportion to the number of tones used. For instance it has been found that for bolt testing a small loudspeaker may be placed several hundred millimetres from the bolt end and reliable measurements achieved for single tone sweeps of about a second and substantially less than a second for multitone sweeps. That the sample need not be held or positioned dramatically reduces the mechanical complexity in a production environment. The method equally applies to any larger sample and may be single ended i.e. the driver and receiver located at one end of the sample. It is found that for bolts, samples 100 mm diameter and of length 300 mm or greater direct coupling of the receiver does not significantly influence the result, the sensor can be selected for dimensions and mass very small compared to the sample thereby minimising sensor cost.

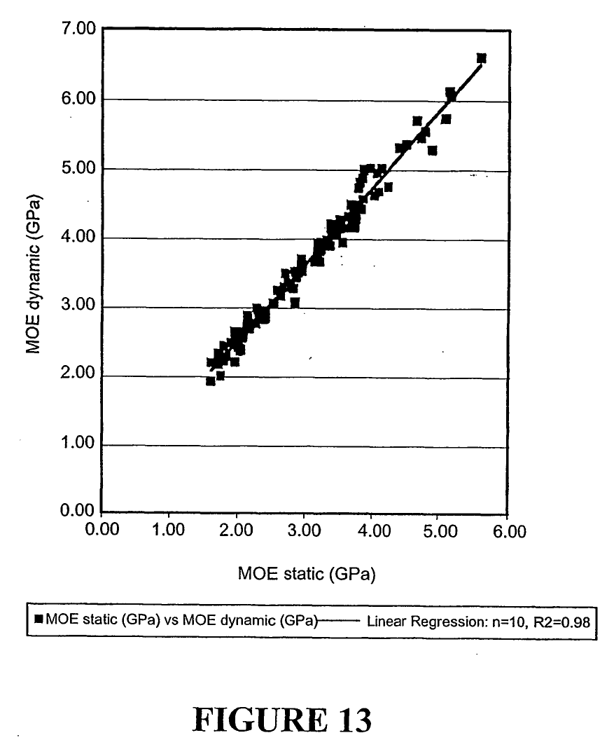

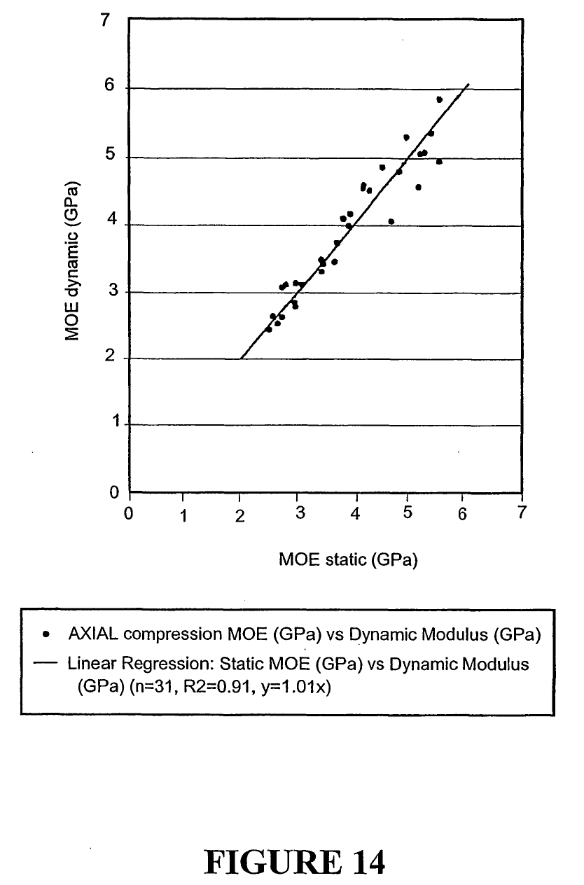

FIG. 13 indicates the outcome of a trial of 110 ASTM size samples of length 300 mm and of cross section 20 mm×20 mm. Swept drive apparatus was used to determine an acoustic velocity from which a ‘dynamic’ acoustic modulus (MOE) can be calculated. The graph plots the acoustic modulus with that measured by static deflection of the sample when loaded by a mass. Clearly the data indicates a good agreement, the correlation coefficient R2 being 0.98. FIG. 14 indicates the outcome of a trial of 31 bolts, sections of length 200 mm to 600 mm of a 3 to 10 year old tree stem, typically the diameter range is 60 mm to 200 mm. The ‘dynamic’ acoustic modulus was determined using swept drive equipment. The bolts were then fitted with displacement sensors and an axial compression applied to determine the static modulus. Given the irregular shape of the samples, being simply debarked tree stem, a good agreement was found, correlation coefficient R2 of 0.91.

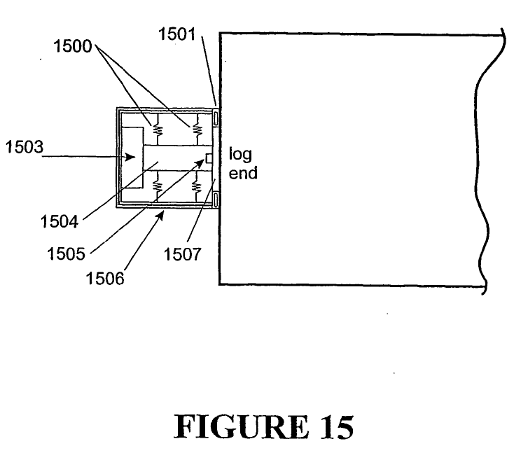

FIG. 15 shows one embodiment of a transmitting transducer and acoustic wave sensor arrangement which can be used for in relation to analysing specimens such as logs or stems. A coupling frame 1506 supports a magnet and coil assembly 1503 which drives a former 1504 to provide the compression force. Alignment dampers 1500 support the former 1504. A coupling face plate 1507 of the frame 1506 is rigidly coupled to an end of the log 1500. An accelerometer is placed at the face plate 1506 to sense the acoustic wave which is generated. For large samples, such as logs about or greater than 2 metres long, loading by the driver motional elements is unlikely to be significant i.e. the natural resonance frequencies are unlikely to be significantly disturbed by the driver mass. In this circumstance the driver motional elements may be rigidly coupled to the sample. A single monitor accelerometer only may be required. The driver stiffness, a combination of the driver source and coil impedance, transformation factor, relating electrical to mechanical quantities, and motional element compliance is chosen along with the excitation levels to match the energy transfer requirements. The accelerometer waveform by itself conveys the resonance signature within the limitations of the drive spectral characteristics. Both conventional dynamic or piezoelectric speakers can be used. Piezoelectric devices prove to be particularly useful since the motional component mass may be as low as 1 gram and the sample and accelerometer may be directly coupled to the piezoelectric element face which is usually flat. A magnetic actuation is used since this provides a wide frequency range controlled actuation with a large possible range in quiescent point, necessary for handheld operation. A pair of alignment dampers maintains the former alignment, the coupling face may be brought into contact with the log directly or via a compliant medium. The unit is sealed and mechanically isolated by the incorporation of the sealing foam.

The loudspeaker and its driving method are chosen to achieve a constant or known amplitude characteristic over the sweep. If wide frequency range conventional dynamic loudspeakers, or some other types, form the basis of the excitation the drive sensing function may be, in an indirect way, achieved by monitoring the driving waveforms. For a loudspeaker excited with a voltage waveform the resultant complex current in the voicecoil is a consequence of the electrical and motional impedances. Typically an exciter system is designed for low losses hence the motional impedance is dominated by the reactive component. The electrical reactive component will be necessarily small, compared to the resistive component, to allow wide bandwidths to be achieved. Thus detection and analysis of the complex current, as could be achieved with the apparatus shown in FIG. 3, could be used as the drive monitor. Except at resonance the cone is largely motionless and consequently the motional impedance large. At resonance the motional impedance is significantly smaller. As above for large samples the drive monitor waveform may display the sample resonances; a receiver accelerometer may not be essential.

The foregoing describes the invention including preferred forms by way of example. Alterations and modifications as will be obvious to those skilled in the art are intended to be incorporated within the scope hereof.

1. A method of determining a characteristic of a wood specimen to assist in optimising use of the specimen including:
exciting the specimen with a frequency varying excitation to impart an acoustic wave into the specimen over a period,
detecting a response based on the frequency of the excitation over said period the response being indicative of the acoustic wave behaviour within the specimen,
determining a response characteristic of the specimen by signal processing the detected response,
determining at least one resonant frequency of the specimen from the response characteristic,
determining an acoustic velocity in the specimen from the at least one resonant frequency,
determining the characteristic using the acoustic velocity.

2. A method according to claim 1 wherein determining the response characteristic further includes using one or more signals indicative of the frequency varying excitation.

3. A method according to claim 1 wherein the characteristic is the acoustic velocity in the specimen.

4. A method according to claim 1 wherein the characteristic is the Modulus of Elasticity (MoE) of the specimen.

5. A method according to claim 4 further including determining the velocity of the acoustic wave in the specimen from the determined resonant frequency and the length of the specimen.

6. A method according to claim 5 further including determining a MoE of the specimen using:
MoE=σV²
where V is the velocity of the acoustic wave in the specimen and ρ is the density of the specimen.

7. A method according to claim 2 wherein the frequency varying excitation is generated according to an excitation signal.

8. A method according to claim 7 wherein the excitation is the output of a transducer which is adapted to impart an acoustic wave in accordance with the excitation signal and which is driven by the excitation signal.

9. A method according to claim 7 wherein the indicative signal is or is derived from the excitation signal.

10. A method according to claim 8 further including sensing the excitation wherein the indicative signal is or is derived from the sensed excitation.

11. A method according to claim 8 further including sensing the excitation wherein a first indicative signal is or is derived from the sensed excitation and a second indicative signal is or is derived from the excitation signal.

12. A method according to claim 1 wherein sensing the response includes sensing the acoustic wave within the specimen.

13. A method according to claim 7 wherein sensing a response includes inspecting the excitation signal to obtain an indication of the acoustic wave behaviour.

14. A method according to claim 7 wherein sensing a response includes sensing the excitation to obtain an indication of the acoustic wave behaviour.

15. A method according to claim 10, 11 or 14 wherein the excitation is sensed at or near an output of the transducer.

16. A method according to claim 7 wherein the excitation signal is frequency varying and substantially continuous over a predetermined period.

17. A method according to claim 16 wherein sensing a response indicative of the behaviour is conducted substantially simultaneous to and over the same period as the predetermined period.

18. A method according to claim 2 wherein determining the response characteristic includes:
sensing the frequency varying excitation to obtain a first indicative signal, and
determining the ratio between the sensed response indicative of the acoustic wave behaviour and the sensed excitation.

19. A method according to claim 18 wherein a second indicative signal is an excitation signal used to generate the frequency varying excitation and wherein determining the ratio includes processing the sensed response and sensed excitation using the excitation signal.

20. A method according to claim 4 wherein determining a resonant frequency includes identifying peaks in the response characteristic which exceed a magnitude threshold, have a shape which substantially correspond to a general resonance model within a predetermined level of fit, and have a shape which falls within a predetermined range.

21. A method according to claim 20 wherein determining a resonant frequency further includes:
identifying groups of peaks which have centre frequencies which substantially correspond with known resonant behaviour of the specimen type,
identifying the group of peaks which best correspond with the known resonant behaviour of the specimen type, and
from the identified group, determining one resonant peak, and
determining the centre frequency of the peak.

22. A method according to claim 21 wherein the resonant peak is determined by analysing two or more of the peaks in the identified group.

23. A method according to claim 1 wherein the excitation has an increasing or decreasing frequency.

24. A method according to claim 1 wherein the excitation has a frequency which is continuously changing at an increasing or decreasing rate.

25. A method according to claim 1 wherein the acoustic wave comprises a plurality of waves at least one of which has a frequency which is increasing or decreasing in frequency.

26. A method according to claim 1 wherein the acoustic wave comprises a plurality of waves at least one of which has a frequency which is continuously changing at a increasing or decreasing rate.

27. Apparatus for determining a characteristic of a wood specimen to assist in optimising use of the specimen including:
a transmitting transducer for coupling to the specimen for generating a frequency varying excitation to impart an acoustic wave in the specimen over a period,
a first receiving transducer adapted to sense a response signal indicative of the behaviour of the imparted acoustic wave and
signal processing means adapted for detecting a response from the response signal based on the frequency of the excitation over said period, for determining a response characteristic from the detected response, and for determining at least one resonant frequency of the specimen from the response characteristic,
wherein the processing means is further adapted for determining an acoustic velocity in the specimen from the at least one resonant frequency, and for determining the characteristic using the acoustic velocity.

28. Apparatus according to claim 27 wherein determining the response characteristic further includes using one or more signals indicative of the frequency varying excitation.

29. Apparatus according to claim 27 wherein the characteristic is the velocity of sound of an acoustic wave in the specimen.

30. Apparatus according to claim 27 wherein the characteristic is the Modulus of Elasticity (MoE) of the specimen.

31. Apparatus according to claim 30 wherein the signal processing means is further adapted to determine the velocity of the acoustic wave in the specimen from the determined resonant frequency and the length of the specimen.

32. Apparatus according to claim 31 wherein the signal processing means is further adapted to determine a MoE of the specimen using:
MoE=ρV²
where V is the velocity of the acoustic wave in the specimen and p is the density of the specimen.

33. Apparatus according to claim 30 further including a waveform generator for generating an excitation signal to drive the transmitting transducer.

34. Apparatus according to claim 33 wherein the indicative signal is or is derived from the excitation signal.

35. Apparatus according to claim 33 further including a second receiving transducer for sensing the frequency varying excitation wherein the indicative signal is or is derived from the sensed excitation.

36. Apparatus according to claim 35 wherein the sensed excitation is a response indicative of the acoustic wave behaviour.

37. Apparatus according to claim 35 wherein a second indicative signal is the excitation signal.

38. Apparatus according to claim 33 wherein the first receiving transducer senses the frequency varying excitation which is indicative of the acoustic wave behaviour.

39. Apparatus according to claim 33 wherein the first receiving transducer senses the acoustic wave within the specimen which is indicative of the acoustic wave behaviour.

40. Apparatus according to claim 33 wherein the first receiving transducer senses the excitation signal which is indicative of the acoustic wave behaviour.

41. Apparatus according to claim 35 wherein the excitation is sensed at or near an output of said second receiving transducer.

42. Apparatus according to claim 33 wherein the excitation signal is frequency varying and substantially continuous over a predetermined period.

43. Apparatus according to claim 42 wherein sensing a response indicative of the behaviour is conducted substantially simultaneous to and over the same period as the predetermined period.

44. Apparatus according to claim 35 or 38 wherein to determine the response characteristic the signal processing means calculates the ratio between the sensed response indicative of the acoustic wave behaviour and the sensed excitation.

45. Apparatus according to claim 44 wherein the signal processing apparatus is further adapted to process the sensed response and sensed excitation using the excitation signal prior to calculating the ratio.

46. Apparatus according to claim 30 wherein to determine a resonant frequency the signal processing means is adapted to identify peaks in the response characteristic which exceed a magnitude threshold, which have a shape which substantially correspond to a general resonance model within a predetermined level of fit, and which have a shape which falls within a predetermined range.

47. Apparatus according to claim 46 wherein to determine a resonant frequency the signal processing means is further adapted to:
identify groups of peaks which have centre frequencies which substantially correspond with known resonant behaviour of the sample type,
identify the group of peaks which best correspond with the known resonant behaviour of the sample type,
from the identified group, determine one resonant peak, and
determine the centre frequency of the peak.

48. Apparatus according to claim 47 wherein to determine one resonant peak the signal processing means analyses two or more of the peaks in the identified group.

49. Apparatus according to claim 27 wherein the frequency varying excitation has an increasing or decreasing frequency.

50. Apparatus according to claim 27 wherein the frequency varying excitation has a frequency which is continuously changing at an increasing or decreasing rate.

51. Apparatus according to claim 27 wherein the frequency varying excitation comprises a plurality of waves at least one of which has a frequency which is increasing or decreasing in frequency.

52. Apparatus according to claim 27 wherein the frequency varying excitation comprises a plurality of waves at least one of which has a frequency which is continuously changing at a linearly increasing or decreasing rate.

53. Apparatus for determining a MoE of a sample log, stem, wood piece or a wooden composite to assist in optimising use of the sample including:
a transducer for coupling to the sample at a first position for generating a frequency varying excitation to impart an acoustic wave into the sample over a period,
a waveform generator to generate an excitation signal to drive the transducer,
a first sensor for placing in proximity to the transducer to sense the frequency varying excitation,
a second sensor for positioning to sense a response signal indicative of the imparted acoustic wave within the sample over said period, and
a signal processor for detecting a response from the response signal based on the frequency of the excitation over said period and for determining a response characteristic of the sample from the detected response, the sensed frequency varying excitation and the excitation signal,
wherein the signal processing means further determines the MoE from the response characteristic.

54. Apparatus for determining a characteristic of a sample log, stem, wood piece or a wooden composite to assist in optimising use of the sample including:
a transducer for coupling to the sample at a first position for generating a frequency varying excitation to impart an acoustic wave into the sample over a period,
a waveform generator to generate an excitation signal to drive the transducer,
a sensor for coupling to the sample to sense a response signal indicative of the imparted acoustic wave over said period, and
a signal processor for detecting a response from the response signal based on the frequency of the excitation over said period, and for determining a response characteristic of the sample from the detected response, and determining at least one resonant frequency of the specimen from the response characteristic,
wherein the signal processor further determines an acoustic velocity in the specimen from the at least one resonant frequency, and determines the characteristic using the acoustic velocity.

55. Apparatus according to claim 54 wherein the transducer is rigidly coupled to the specimen, and whereby the excitation signal can be inspected to sense the excitation as an indicative response.

56. Apparatus for determining a characteristic of a log or stem to assist in optimising use, the apparatus adapted for use with harvesting equipment and including:
one or more drive rollers adapted to move the log or stem longitudinally
a waveform generator to generate an excitation signal which stimulates the drive rollers to oscillate and excite the log or stem,
a first sensor adapted to sense the excitation signal,
a second sensor adapted to sense the response of the log or stem during oscillation, and
a signal processor for determining a response characteristic of the sample from the sensed response and the sensed excitation signal,
wherein the signal processing means further determines the characteristic from the response characteristic.

57. A method for assessing or predicting a MoE of a specimen of a tree stem, log or wood piece, or of a wood composite material comprising exposing the specimen to a continuous excitation energy which varies at least in frequency over a defined time period, detecting the resultant acoustic wave energy in the specimen over the same time period based on the frequency of the excitation over said period via a receiver coupled to the specimen, and determining the MoE of the specimen using the detected signal.

58. Apparatus for assessing or predicting a MoE of a specimen of a tree stem, log or other wood piece, or of a wood composite material, comprising transducer means arranged to expose the specimen to excitation energy which varies at least in frequency over a defined time period, receiver means arranged to detect the excitation energy in the specimen over the same time period based on the frequency of the excitation over said period, and means arranged to determine the MoE of the specimen from the detected signal.

59. A method of determining a characteristic of a wood specimen to assist in optimising use of the specimen;
exciting the specimen with a frequency varying excitation to impart an acoustic wave into the specimen at a first location over a period,
based on the frequency of the excitation over said period detecting a response indicative of the acoustic wave behaviour within the specimen, at a single location different form the first location,
determining a response characteristic of the specimen by signal processing the detected response from the single location,
determining at least one resonant frequency of the specimen from the response characteristic, and
determining the characteristic using one determined resonant frequency.

60. Apparatus for determining a characteristic of a wood specimen to assist in optimising use of the specimen, including:
a transmitting transducer for coupling to the specimen for generating a frequency varying excitation to impart an acoustic wave in the specimen at a first location in the specimen over a period,
a receiving transducer adapted to sense a response signal over said period, at a single location in the specimen different from the first location, indicative of the behaviour of an imparted acoustic wave, and
a signal processing means adapted for detecting a response from the response signal based on the frequency of the excitation over said period, for determining a response characteristic from the detected response at the single location, and for determining at least one resonant frequency of the specimen from the response characteristic, wherein the processing means is further adapted for determining the characteristic using one determined resonant frequency.

61. Apparatus for determining a characteristic of a specimen log, stem, wood piece or a wooden composite to assist in optimising use of the specimen including:
a transducer for coupling to the sample at a first location for generating a frequency varying excitation to impart an acoustic wave into the specimen over a period,
a wave form generator to generate an excitation signal to drive the transducer,
a sensor for coupling to the sample to sense a response signal, over said period, indicative of the imparted acoustic wave at a single location different from the first location, and
a signal processor for detecting a response from the response signal based on the frequency of the excitation over said period, for determining a response characteristic of the specimen from the detected response at the single location, and for determining the at least one resonant frequency of the specimen from the response characteristic,
wherein the signal processing means further determines the characteristic using one determined resonant frequency.
